(19) United States
(12) Patent Application Publication
(10) Pub. No.: US 2009/0230370 A1
(43) Pub. Date: Sep. 17, 2009

(54) Quick connect coupler

(76) Inventor: Augustine Eugene DelCoglin, Wilmington, DE (US)

Correspondence Address: Jerome Sacks, Patent Agent, PO Box 601, Lexington, MA, 02420, US

(21) Appl. No.: 12/381,208

(22) Filed: Mar. 9, 2009

Related U.S. Application Data
(60) Provisional application No. 61/036,382, filed on Mar. 13, 2008.

(51) Int. Cl. B25B 27/14

(52) U.S. Cl. 254/234

(57) ABSTRACT

The invention comprises a first and a second assembly and a screw designed for tight mating of a hose coupler of a specified diameter. Each assembly has an open-ended slot that releasably accommodates one member of the hose coupler. The screw is rotationally joined to the first and second assemblies. The first assembly and second assembly are slidingly constrained to traverse in-line along a single axial direction coinciding with the major axis of the comprising: When the coupler components are inserted, one in each open-ended slot of each assembly, and the comprising: is rotated in a first rotational direction, the coupler components are urged towards each other. When the comprising: is rotated in a second rotational direction, the open-ended slots of the assemblies are urged apart, releasing the coupler components. An auxiliary component pair allows the invention to be used with smaller couplers.

### CROSS-REFERENCE TO RELATED APPLICATIONS:

This application claims the benefit of the U.S. Provisional Patent Application No. 61/036,382 filed Mar. 13, 2008 by the present inventor. This provisional patent application is incorporated herein by reference.

### FIELD OF THE INVENTION

This invention relates to devices that facilitate the tight mating of hose couplers such as air hoses and hydraulic hoses; in particular to devices that tightly mate and release hose couplers quickly.

### BACKGROUND OF THE INVENTION

There are many devices that facilitate the mating of hose or pipe couplers. Some are designed with clamps that are joined to the hose coupler components and have screw-based guides that when rotated urge the male and female ends together. Others have cam devices temporarily or permanently joined to the pipe or hose components that can be ratcheted to urge the coupler components together. Still others require that the hose couplers have a proprietary design that will accommodate the device. Still others have a wrench-like design that will work with hose couplers of a particular diameter only.

While each of these devices are appropriate for some applications, they have limited applicability in meeting all the design requirements of the invention presented herein.

### SUMMARY OF THE INVENTION

The inventive solution presented herein is a quick connect coupler device that works with hose male/female hose coupler components. The quick connect coupler engages and tightly mates the hose coupler by a quick insertion of the coupler components into open-ended slots disposed on the device and then rotating the device's hexheaded screw with a standard wrench. The device quickly releases the coupler components by reversing this procedure. It ensures a tightly mated coupler that prevents leaks in a high-pressure environment and may be applied to hoses of varying diameters using a pair of auxiliary components. What is novel is that the hose coupler components may be inserted in the device easily, turning a single screw with a standard wrench tightly mates the coupler, and the auxiliary components allow couplers of smaller diameters to be used with the device. The hose coupler is not part of the invention.

The embodiment of the invention presented herein is a device comprising a male inverted L-shaped assembly, a female inverted L-shaped assembly, a hexheaded screw that connects the two assemblies together, and an additional pair of components that allows the invention to be used with smaller diameter hose couplers. The assemblies have guides that, together with the screw, snugly restrict motion of the male and female assemblies in-line along a single axial direction. The side subassembly component of each assembly has an open-ended slot that rapidly engages and constrains a hose coupler component.

### BRIEF DESCRIPTION OF THE DRAWINGS

FIG. 1 illustrates a perspective view of a prior art hose coupler with female and male components.

FIG. 2 illustrates a perspective view of the embodiment with the hose coupler female and male components positioned in a disengaged mode.

FIGS. 3 and 3A illustrate a perspective view of the embodiment with the hose coupler tightly mated.

FIGS. 4A and 4B illustrate a perspective view of the female and male assemblies respectively of the embodiment.

FIGS. 5A and 5B illustrate exploded views of the components of the female and male assemblies respectively of the embodiment.

FIG. 6A illustrates a front cross sectional view of the female assembly of the embodiment.

FIG. 6B illustrates a left side cross sectional view of the male assembly of the embodiment.

FIG. 7 illustrates the hexheaded screw and washer.

FIG. 8 illustrates a perspective view of the embodiment with cross section indicators.

FIG. 9 illustrates a left side cross section of the embodiment.

FIG. 10 illustrates a front cross section view of the embodiment.

FIG. 11 illustrates an auxiliary component that allows the embodiment to be used for hose couplers of smaller diameter.

FIG. 12 illustrates two perspective views of the use of auxiliary components.

### DETAILED DESCRIPTION OF THE INVENTION

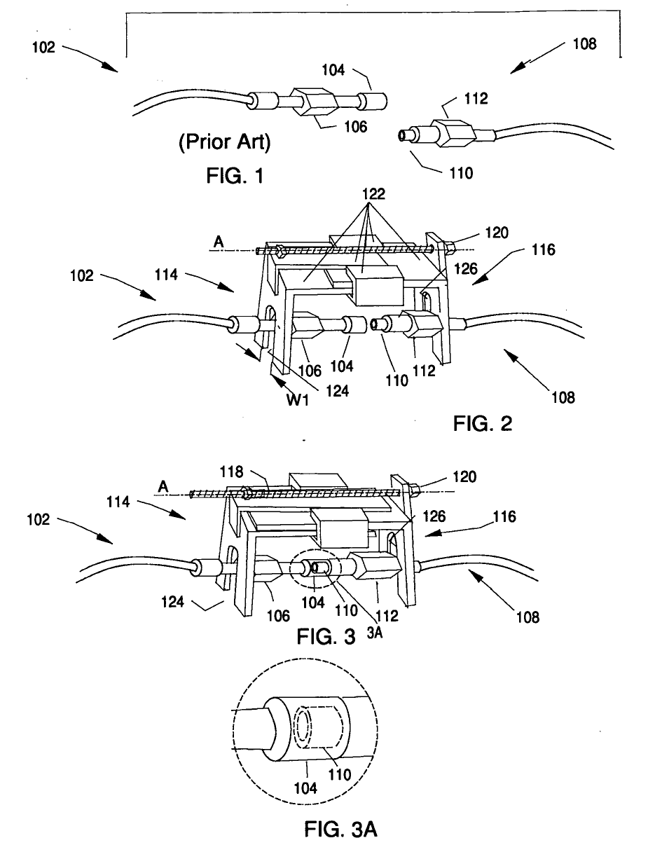

FIGS. 1 through 3 illustrate an overview of an embodiment of the invention applied to a hose coupler.

FIG. 1 illustrates a prior art mateable coupler comprising a female hose coupler component 102 and a male hose coupler component 108. In normal use, the male end 110 of coupler component 108 is inserted into the female end 104 of the hose coupler component 102 thereby mating the coupler. The hose coupler components shown in FIG. 1 have hex nuts 106 and 112 located on the female and male coupler components respectively. In a high-pressure environment, the mated coupler may leak. This invention is directed to a device that quickly tightly mates the hose coupler components. The invention applies to hose or pipe couplers that may depart from the design shown in FIG. 1. For example the hex nuts may be replaced by knurled rings. The mateable coupler is not part of the invention.

In the following description, the embodiment is directed to a coupler that has a hose diameter of a fixed dimension, for example, a hose diameter of 2.54 cm (1 inch). The embodiment is dimensioned to fit this hose coupler diameter. This embodiment may be modified apply to a hose coupler of a different diameter. Furthermore, although the embodiment shows the female hose component 102 being used with the female assembly 114; this may be reversed such that the male hose component 108 is used with the female assembly 102.

FIG. 2 illustrates the embodiment with the hose coupler in a disengaged mode. The embodiment consists of a female assembly 114 and a male assembly 116 with guides 122 that snugly restrict the relative motion of the two assemblies in-line along a single axial direction A. The female 114 and male 116 assemblies each have an open-ended slot 124 and 126 respectively as illustrated in FIG. 2. The width W1 of the open-ended slot is dimensioned to accommodate the hose coupler such that the assemblies constrain the hex nuts 106 and 112 from sliding through these open-ended slots, yet allow the hose coupler components to fit in the open-ended slots. The embodiment has a hexheaded screw 118 that connects the female and male assemblies 114 and 116 and is used to adjust the distances between the two open-ended slots 124 and 126. The assemblies are dimensioned to accommodate unmated coupler components and allow the tight mating of the coupler.

Refer now to FIGS. 2 and 3. To use the embodiment, the assemblies are disposed as shown in FIG. 2 to accommodate the female and male components when they are inserted in the open-ended slots 124 and 126. The coupler component hex nuts 106 and 112 are constrained by the open-ended slots 124 and 126 with the female 104 and male 110 ends of the coupler facing each other. The user then rotates the screw hexhead 120 in a first rotational direction so that the two open-ended slots constraining the coupler hex nuts are urged towards each other. The user continues to turn the hexhead so the female and male ends mate as shown in FIG. 3. The screw hexhead 120 is rotated further in the first rotational direction until the coupler tightly mates. FIG. 3 illustrates the embodiment in a tightly mated mode. To release the mated coupler from the embodiment, the hexhead is rotated in a second rotational direction opposite to the first rotational direction, releasing the pressure on the coupler components. The coupler is then removed from the embodiment and separated manually. FIG. 3A shows a detail of a portion of FIG. 3. In FIG. 2, the hose coupler component ends 104 and 110 are shown to be completely separated. The embodiment functions equally well if the hose coupler ends are loosely mated before inserted in the embodiment.

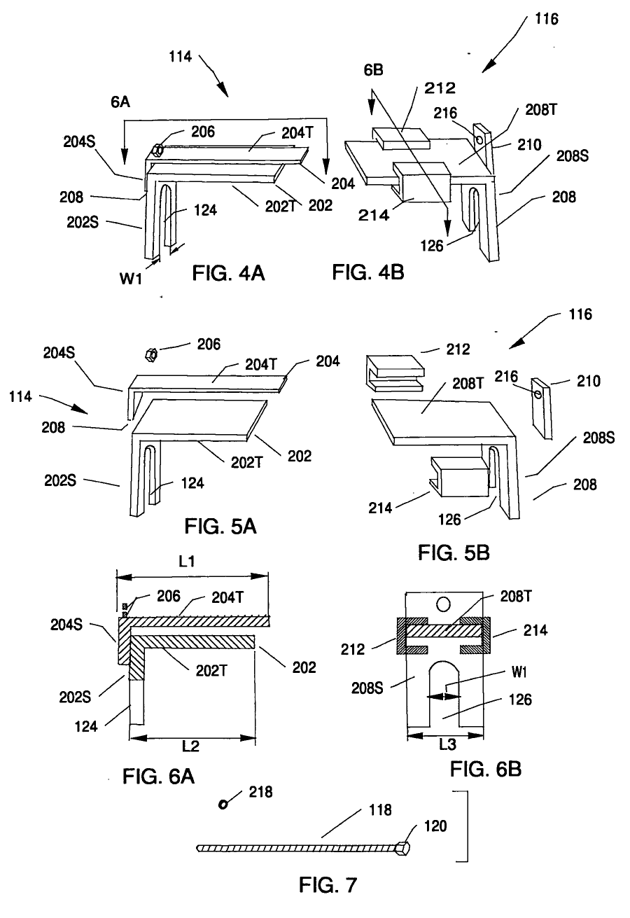

FIGS. 4A and 4B illustrate the components and configuration of the female and male assemblies. FIGS. 5A and 5B present an exploded view of the assemblies. FIG. 6A illustrates a front sectional view of the female assembly 114. FIG. 6B illustrates a left side sectional view of the male assembly 116.

Referring to FIGS. 4A, 5A and 6A, the female assembly 114 is constructed from three components: a bottom component 202, a top component 204, and a hex nut 206. The bottom component 202 is L-shaped with a top subcomponent 202T shaped as a rectangular solid and a side subcomponent 202S shaped as a rectangular solid. They are joined at approximately right angles to form the bottom component 202. The side subcomponent 202S has an open-ended slot 124. The open-ended slot 124 has width W1 so it can accommodate the hose coupler component 102 but will constrain the hose hex nuts 106 from passing through. The top component 204 has a top subcomponent 204T shaped as a rectangular solid and a side component 204S shaped as rectangular solid The two components 204T and 204S meet at right angles. The three components 206, 204 and 202 of the female assembly 114 are joined as shown in FIGS. 4A and 6A.

Referring to FIGS. 1, 4B, 5B and 6B, the male assembly 116 is composed of four components: an L-shaped component 208, a flat component 210, and two three-sided brackets 212 and 214. The L-shaped component 208 is composed of a top subcomponent 208T having a rectangular solid shape and a side subcomponent 208S also having a rectangular solid shape. They are joined at approximately right angles to form the single component 208. The side subcomponent 208S has an open-ended slot 126 of width W1. The open-ended slot 126 is open at the bottom so it can accommodate the hose coupler component but will prevent the hose hex nut 112 from passing through. The two three-sided brackets 212 and 214 are joined to the top subcomponent 208T on either side. The flat component 210 is joined to the side subcomponent 208S of the male assembly 116 as shown in FIG. 4B. It has an aperture 216 that allows the screw 118 to pass through.

FIG. 6A illustrates a front cross-section of the female component 114. FIG. 6B illustrates a left side cross-section view of the male component 116. The space between the top subcomponent 204T and the bottom subcomponent 202T of the female assembly 114 is dimensioned so it will accommodate the top subcomponent 208T of the male assembly 116, and snugly fits slidingly between the top subcomponent 204T and the bottom subcomponent 202T. The three-sided brackets 212 and 214 are joined at the top and sides of the subcomponent 208T of the L-shaped subcomponent 208 of the male assembly 116 as shown in FIGS. 4B and 6B.

FIG. 7 illustrates the hexheaded screw 118 and a washer 218 used in the embodiment.

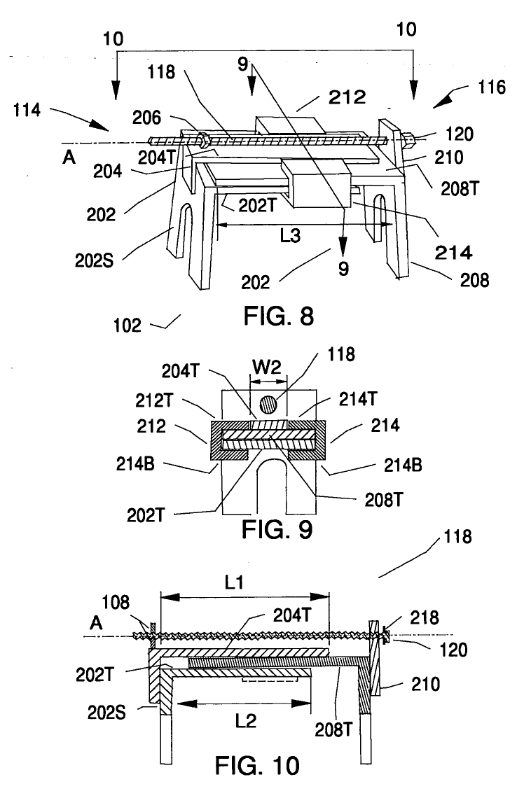

FIG. 8 illustrates the assembled embodiment of the invention with two cross section indicators. FIG. 9 illustrates a left side cross-section of the embodiment. FIG. 10 illustrates a front cross-section of the embodiment. Referring to FIG. 9, the top subcomponent 204T of the female assembly 114 has width W2 so it fits between the top 212T and 214T of the three-sided components 212 and 214 with enough clearance so it slides snugly and freely in-line along the axial direction A. The widths of the subcomponents 208T and the bottom subcomponent 202T are the same. The thickness of the subcomponent 202T is dimensioned so it fits between the top subcomponent 208T and the bottom 212B and 214B of the three-sided brackets 212 and 214. The five components 212, 214, 202T, 204T, and 208T function together as guides to keep the two assemblies 114 and 116 in-line such that the assemblies are constrained to slide along a single axial direction A. The dimensions of the five components are configured so the two assemblies snugly slide along the single axial direction.

Referring now to FIGS. 2, 8 and 10, the lengths L1, L2 and L3 of the subcomponents 204T, 202T and 208T respectively are dimensioned such that when the embodiment is in the disengaged mode as shown in FIG. 2, the male and female assemblies may accept the two hose coupler male/female components, and when in the tightly mated configuration of FIG. 3, the assembly will tightly mate the coupler. FIG. 10 also shows the use of the washer 218 that facilitates the rotation of the screw.

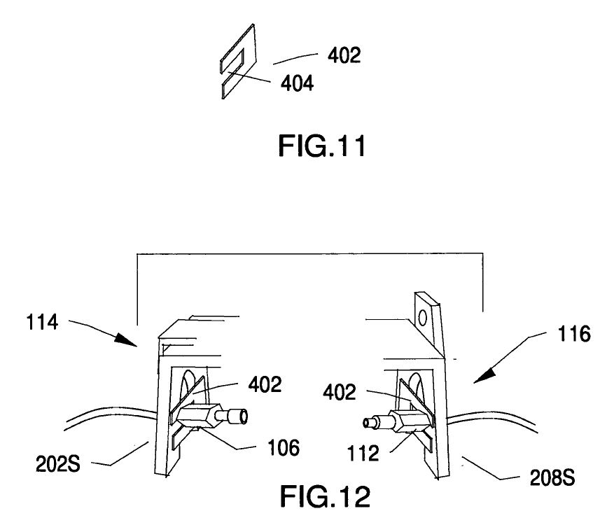

FIG. 11 illustrates an auxiliary component 402 with a rectangular open-ended slot 404. A pair of these auxiliary components allows the embodiment, that is dimensioned to accept hose couplers of a specified diameter, to be used with hose couplers of a smaller diameter. For example, suppose the embodiment discussed above is dimensioned such that it accommodates hose couplers of a diameter 2.54 cm (1 inch). Referring now to FIG. 12, to accommodate hose couplers of diameter 1.9 cm (¾ inch), the auxiliary component has an open-ended slot 404 dimensioned to accommodate hose couplers of a diameter 1.9 cm (¾ inch). The component 402 is dimensioned such that it will be constrained by the sides 202S and 208S as shown in FIG. 12 when the auxiliary components are disposed as in FIG. 12. When the pair of auxiliary components 404 and hose coupler components 102 and 108 are disposed as shown in FIG. 12, the embodiment tightly mates the hose coupler with a smaller diameter.

The embodiment presented herein is considered as only illustrative of the invention and not a limitation of the scope of the invention. Various variations and extensions of this embodiment are considered to fall within the scope of this invention. The invention applies to air hoses, hydraulic hoses and other hoses and pipes with a similar coupler mechanism. It may be dimensioned to apply to hoses of any specified diameter. The in-line mechanism that snugly restricts assembly movement in a direction along a single axis may be replaced by other in-line mechanisms that accomplish the same function. The hexheaded screw may be replaced by a threaded shaft of a different design the performs the same function; for example a screw having a crank instead of a hexhead. The nut may be replaced by a threaded component that engages the threaded shaft. The auxiliary components may have stepped slots to accommodate couplers of more than one diameter. Therefore the scope of this invention should be determined with reference to the claims and not just by the embodiment presented herein.

What is claimed is:

1. A device for mating and releasing a hose coupler first component and a hose coupler second component of a hose coupler of a specified diameter comprising:
a first assembly, a second assembly and a threaded shaft,
said first assembly releasably engaging said first hose coupler component, and said second assembly releasably engaging said second hose coupler component,
said first assembly and said second assembly slidingly constrained to move in a single axial direction,
said threaded shaft rotationally engaging said first assembly and said second assembly, said threaded shaft being disposed such that when said threaded shaft is rotated in a first rotational direction the sliding urges said first assembly towards said second assembly along said single axial direction, and when said threaded shaft is rotated in a second rotational direction said first assembly is slidingly movable away from said second assembly along said single axial direction,
wherein when said first coupler component is engaged by said first assembly and said second coupler component is engaged by said second assembly and said threaded shaft is rotated in said first rotation direction, then said coupler components are urged towards each other until they are mated,
and wherein said threaded shaft is rotated in said second rotational direction said first assembly and said second assembly releasing the pressure on said coupler such that said coupler is removable from said device.

2. The device of claim 1 further comprising:
a first auxiliary component releasably engaging said hose coupler first component of a hose coupler of a smaller diameter and,
a second auxiliary component releasably engaging said hose coupler second component of a hose coupler of said smaller diameter,
wherein said first auxiliary component is disposed against said first assembly and said second auxiliary component is disposed against said second assembly with said first and said second hose coupler components being engaged by said first and said second auxiliary components, said device with said first and said second auxiliary components mating said hose coupler of said smaller diameter when said screw is rotated in said first rotational direction.

3. The device of claim 1 wherein said hose coupler has diameter 2.54 cm (1 inch).

4. The device of claim 2 wherein said first auxiliary component and said second auxiliary component releasably engages a hose coupler of diameter 1.9 cm (¾ inch).

5. A device for mating and releasing a hose coupler first component and a hose coupler second component of a hose coupler of a specified diameter comprising:
a first assembly, a second assembly and a screw,
a first open-ended slot disposed on said first assembly releasably engaging said first hose coupler component, and a second open-ended slot disposed on said second assembly releasably engaging said second hose coupler component,
a plurality of guides for slidingly constraining said first assembly and said second assembly to traverse along a single axial direction,
said screw rotationally engaging said first assembly and said second assembly, said screw being disposed such that when said screw is rotated in a first rotational direction the sliding urges said first assembly towards said second assembly along said single axial direction, and when said screw is rotated in a second rotational direction, said first assembly is slidingly movable away from said second assembly along said single axial direction,
wherein when said first coupler component is engaged by said first assembly said first open-ended slot and said second coupler component is engaged by said second assembly said second open-ended slot, and said screw is rotated in said first rotation direction, then said coupler components are urged towards each other until they are mated, and
wherein said screw is rotated in said second rotational direction then said first open-ended slot of said first assembly and said second open-ended slot of said second assembly releasing pressure on said coupler such that said coupler is removable from said device.

6. The device of claim 5 further comprising:
a first auxiliary component releasably engaging said hose coupler first component of a hose coupler of a smaller diameter, and
a second auxiliary component releasably engaging said hose coupler second component of a hose coupler of said smaller diameter,
wherein said first auxiliary component is disposed against said first assembly and said second auxiliary component is disposed against said second assembly with said first and said second hose coupler components being engaged by said first and said second auxiliary components, said device with said first and said second auxiliary components mating said hose coupler of said smaller diameter when said screw is rotated in said first rotational direction.

7. The device of claim 5 wherein said hose coupler has diameter 2.54 cm (1 inch).

8. The device of claim 6 wherein said first auxiliary component and said second auxiliary component releasably engages a hose coupler of diameter 1.9 cm (¾ inch).

9. A device for mating and releasing a hose coupler first component and a hose coupler second component of a hose coupler of given diameter comprising:
a first assembly comprising a first L-shaped component with a first top and a first side, a second L-shaped component with a second top and a second side, and a nut,
a second assembly comprising a third L-shaped component with a third top and a third side, a flat component having an aperture, a first three-sided bracket and a second three-sided bracket,
a screw that slidingly fits through said aperture and is received by said nut,
a first open-ended slot on said first side of said first L-shaped component of said first assembly releasably engaging said first component of said hose coupler, and a second open-ended slot on said third side of said second L-shaped component of said second assembly releasably engaging said second component of said hose coupler,
said first assembly first L-shaped component of said first side and said first assembly second L-shaped component of said second side being joined,
said nut being joined to said first L-shaped component second top,
said first three-sided bracket of said second assembly being joined to a first side of said third top of said second L-shaped bracket of said second assembly,
said second three-sided bracket of said second assembly being joined to a second side of said third top of said second L-shaped bracket of said second assembly,
said flat component of said second assembly being joined to said second assembly said third side,
said first assembly, said second assembly and said screw dimensioned and configured such that said first assembly slidingly engages said second assembly with sliding restricted to traversing along a single axial direction, said screw being received by said nut of said first assembly and passing through said aperture of said flat component of said second assembly, with said screw-longitudinal axis being disposed along said-single axial direction,
wherein when said screw is rotated in a first rotational direction, said first side of said first L-shaped component of said first assembly and said third side of said second L-shaped component of said second assembly being urged towards each other, and
wherein when said screw is rotated in a second rotational direction said first side of said first L-shaped component of said first assembly and said third side of said L-shaped component of said second assembly are slidingly movable away from each other,
whereby when said hose coupler first component being engaged by said first assembly first open-ended slot, and said hose coupler second component being engaged by said second assembly second open-ended slot, said screw being rotated in said first rotational direction urges the first and second coupler components towards each other until they are mated, and when rotating said screw in said second rotational direction, said open-ended slots are movable away from each other such that said coupler is releasable from said device.

10. The device of claim 9 further comprising:
a first auxiliary component comprising a first flat component with a first rectangular open-ended slot, said first rectangular open-ended slot of said first auxiliary component releasably engaging a hose coupler first component of a hose-coupler-of a smaller diameter,
a second auxiliary component comprising a second flat component with a second rectangular open-ended slot, said second rectangular open-ended slot of said second auxiliary component releasably engaging a hose coupler second component of a hose coupler of said smaller diameter,
wherein when said first auxiliary component is disposed against said first side of said first assembly and said auxiliary second component is disposed against said third side of said second assembly with first and second hose coupler components being engaged by first and second auxiliary components, said device with said first and said second auxiliary components mating said hose coupler of said smaller diameter when said screw is rotated in said first rotational direction.
